(19) United States
(12) Patent Application Publication
(10) Pub. No.: US 2026/0313628 A1
(43) Pub. Date: Oct. 8, 2026

(54) BEAM AND SUB-BAND MAPPING IN JOINT TIME PHASE ARRAYS

(71) Applicant: Samsung Electronics Co., Ltd., Suwon-si (KR)

(72) Inventors: Ahmad AlAmmouri, Plano, TX (US); Young Han Nam, Plano, TX (US)

(21) Appl. No.: 19/577,228

(22) Filed: Mar. 24, 2026

Related U.S. Application Data
(60) Provisional application No. 63/783,859, filed on Apr. 4, 2025.

(51) Int. Cl. H04W 72/044; H04L 5/00

(52) U.S. Cl. CPC H04W 72/046; H04L 5/0046

(57) ABSTRACT

Apparatuses and methods for beam and sub-band (SB) mapping joint phase-time arrays (JPTAs). In some embodiments, method for operating a base station (BS) is provided. The method includes assigning a contiguous set of resource blocks (RBs) to beams of a JPTA and configuring at least one time delay generated by at least one time delay unit and at least one phase shifter to generate a contiguous SB allocation.

### CROSS-REFERENCE TO RELATED APPLICATION AND CLAIM OF PRIORITY

This application claims priority under 35 U.S.C. § 119(e) to U.S. Provisional Patent Application No. 63/783,859 filed on Apr. 4, 2025. The above-identified provisional patent application is hereby incorporated by reference in its entirety.

### TECHNICAL FIELD

This disclosure relates generally to wireless networks. More specifically, this disclosure relates to apparatuses and methods for beam and sub-band (SB) mapping in joint phase-time arrays (JPTAs).

### BACKGROUND

As wireless communication has grown and the number of subscribers to wireless communication services continues to grow quickly, the demand for wireless data traffic is rapidly increasing due to the growing popularity among consumers and businesses. To meet the high growth in mobile data traffic and support new applications and deployments, improvements in radio interface efficiency and coverage are of paramount importance. Moreover, this demand for wireless data traffic has increased since the deployment of 4G communication systems, and to enable various vertical applications, 5G (e.g., fifth generation) communication systems have been developed and are currently being deployed. Several characteristics of such applications have also been considered.

### SUMMARY

This disclosure provides apparatuses and methods for beam and SB mapping in JPTAs

In one embodiment, a method for operating a base station (BS) is provided. The method includes assigning a contiguous set of resource blocks (RBs) to beams of a JPTA, and configuring at least one time delay generated by at least one time delay unit and at least one phase shifter to generate a contiguous SB allocation.

In another embodiment, a BS is provided. The BS includes an antenna element (AE) array including at least one row of AEs and at least one column of AEs, at least one time delay unit, wherein a time delay unit is coupled to each row of AEs, a time delay unit is coupled to each column of AEs, or a time delay unit is coupled to each of the AEs, and at least one phase shifter connected to each of the AEs, wherein the BS is configured to assign a contiguous set of resource blocks (RBs) to beams of a JPTA, and configure at least one time delay generated by the at least one time delay unit and at least one phase shifter to generate a contiguous SB allocation.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to the present disclosure;

FIG. 3A illustrates an example UE according to the present disclosure;

FIG. 3B illustrates an example gNB according to the present disclosure;

FIG. 4 illustrates an example beamforming architecture that may be used in connection with either hybrid beamforming for O-RAN fronthaul or transmission of control information over O-RAN fronthaul for JPTAs according to the present disclosure;

FIG. 5 illustrates a diagram of an example phase-shifter based frequency-flat hybrid beamforming according to embodiments of the present disclosure;

FIG. 6 illustrates an example of a JPTA beamforming on a beam set according to various embodiments of the present disclosure;

FIG. 7 illustrates a diagram of an example JPTA circuit according to embodiments of the present disclosure;

FIG. 8 illustrates an example of a JPTA beam pattern for a two-dimensional (2D) beam pattern for JPTA discrete-angle beam according to embodiments of the present disclosure;

FIG. 9 illustrates an example array of antenna elements (AEs) used in three-dimensional (3D) JPTA according to embodiments of the present disclosure;

FIG. 10 illustrates an example array of AEs used in azimuth-only JPTA according to embodiments of the present disclosure;

FIG. 11 illustrates an example JPTA beam according to embodiments of the present disclosure;

FIG. 12 illustrates an example sub-band (SB) assignment for the example JPTA beam of FIG. 11 without any scheduling restrictions according to embodiments of the present disclosure;

FIG. 13 illustrates an example SB assignment for the example JPTA beam of FIG. 11 with contiguous SB allocation according to embodiments of the present disclosure;

FIG. 14 illustrates an example SB assignment for the example JPTA beam of FIG. 11 without any scheduling restrictions for azimuth-only JPTA according to embodiments of the present disclosure;

FIG. 15 illustrates an example SB assignment for the example JPTA beam of FIG. 11 using monotone SB and beam mapping according to embodiments of the present disclosure;

FIG. 16 illustrates a flowchart for an example method for margining user beams according to one or more embodiments of the present disclosure; and

FIG. 17 illustrates a flowchart for an example method for beam and SB mapping in JPTAs according to an embodiment of the present disclosure.

### DETAILED DESCRIPTION

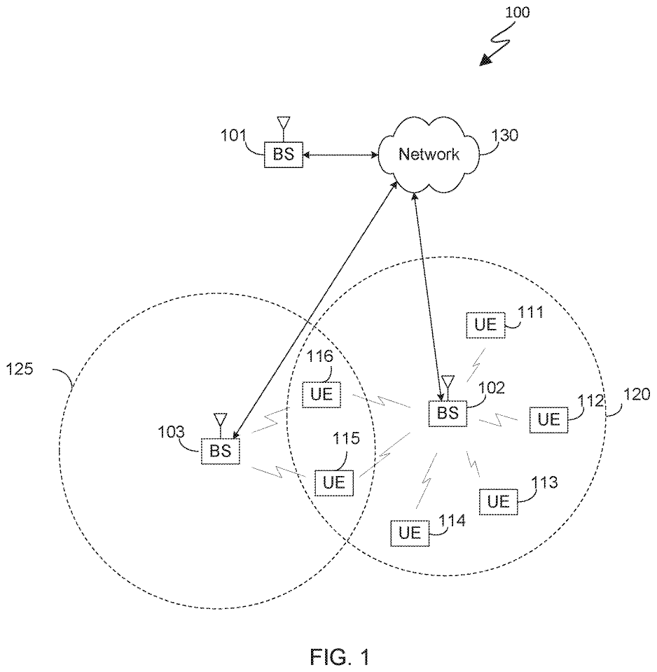

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since the deployment of 4G communication systems, efforts have been made to develop a 6G, improved 5G or pre-6G communication system. Therefore, the 5G or pre-5G communication system is also called a “beyond 4G network” or a “post LTE system.”

The 5G communication system is implemented in higher frequency (mmWave) bands, e.g., 60 GHz bands, to accomplish higher data rates. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, and discussed in 6G communication systems development for system network improvement is underway based on advanced small cells, cloud radio access networks (RANs), ultra-dense networks, device-to-device (D2D) communication, wireless backhaul communication, moving network, cooperative communication, coordinated multi-points (CoMP) transmission and reception, interference mitigation and cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and non-limiting embodiments of the present disclosure may be utilized in connection with any frequency band. For example, aspects of the present disclosure may also be applied to the deployment of 5G communication systems, 6G or even later releases which may use terahertz (THz) bands.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or another data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 include circuitry, programing, or a combination thereof to utilize beam and sub-band (SB) mapping in joint phase-time arrays.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

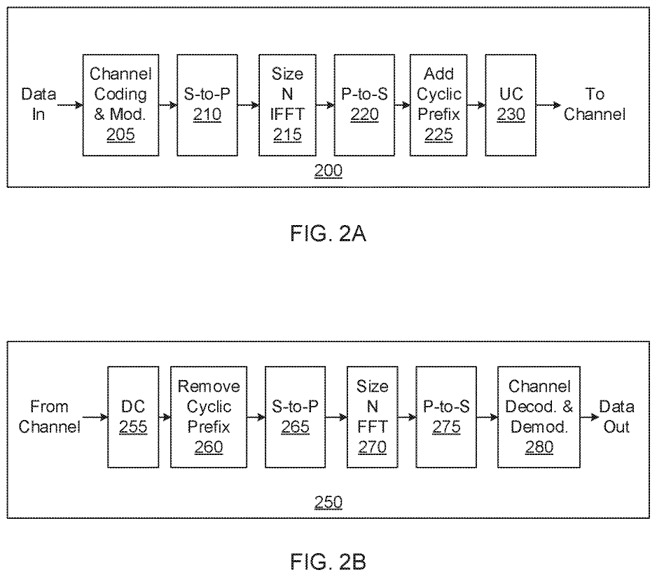

FIGS. 2A and 2B illustrate example wireless transmit and receive paths according to the present disclosure. In the following description, a transmit path 200 can be described as being implemented in a gNB (such as gNB, or base station (BS), 102), while a receive path 250 can be described as being implemented in a UE (such as UE 116). However, it will be understood that the receive path 250 could be implemented in a gNB and that the transmit path 200 could be implemented in a UE. In some embodiments, the transmit path 200 is configured to utilize beam and SB mapping JPTAs as described in various embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an ‘add cyclic prefix’ block 225, and an up-converter (UC) 230. The receive path 250 includes a down-converter (DC) 255, a ‘remove cyclic prefix’ block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as convolutional, Turbo, or low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The S-to-P block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The P-to-S block 220 converts (such as multiplexes) the parallel time-domain output symbols from the size N IFFT block 215 in order to generate a serial time-domain signal. The ‘add cyclic prefix’ block 225 inserts a cyclic prefix to the time-domain signal. The UC 230 modulates (such as up-converts) the output of the ‘add cyclic prefix’ block 225 to an RF frequency for transmission via a wireless channel. The signal can also be filtered at baseband before conversion to the RF frequency.

A transmitted RF signal from the gNB 102 arrives at the UE 116 after passing through the wireless channel, and reverse operations to those at the gNB 102 are performed at the UE 116. The DC 255 down-converts the received signal to a baseband frequency, and the ‘remove cyclic prefix’ block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 can implement a transmit path 200 that is analogous to transmitting in the downlink to UEs 111-116 and can implement a receive path 250 that is analogous to receiving in the uplink from UEs 111-116. Similarly, each of UEs 111-116 can implement a transmit path 200 for transmitting in the uplink to gNBs 101-103 and can implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B can be implemented in software, while other components can be implemented by configurable hardware or a mixture of software and configurable hardware. For instance, the FFT block 270 and the IFFT block 215 can be implemented as configurable software algorithms, where the value of size N can be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, could be used. It will be appreciated that the value of the variable N can be any integer number (such as 1, 2, 3, 4, or the like) for DFT and IDFT functions, while the value of the variable N can be any integer number that is a power of two (such as 1, 2, 4, 8, 16, or the like) for FFT and IFFT functions.

Although FIGS. 2A and 2B illustrate examples of wireless transmit and receive paths, various changes can be made to FIGS. 2A and 2B. For example, various components in FIGS. 2A and 2B could be combined, further subdivided, or omitted, and additional components could be added according to particular needs. Also, FIGS. 2A and 2B are meant to illustrate examples of the types of transmit and receive paths that could be used in a wireless network. Other suitable architectures could be used to support wireless communications in a wireless network.

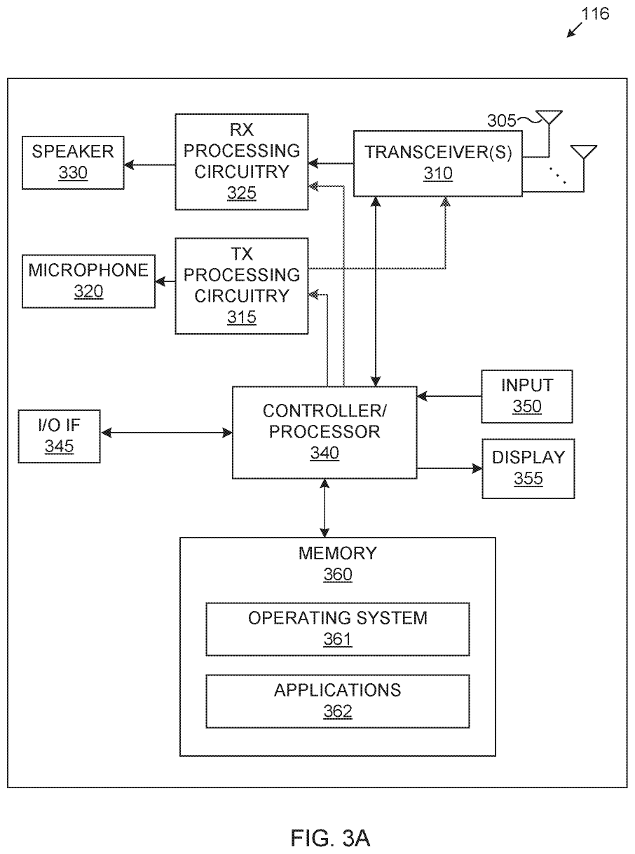

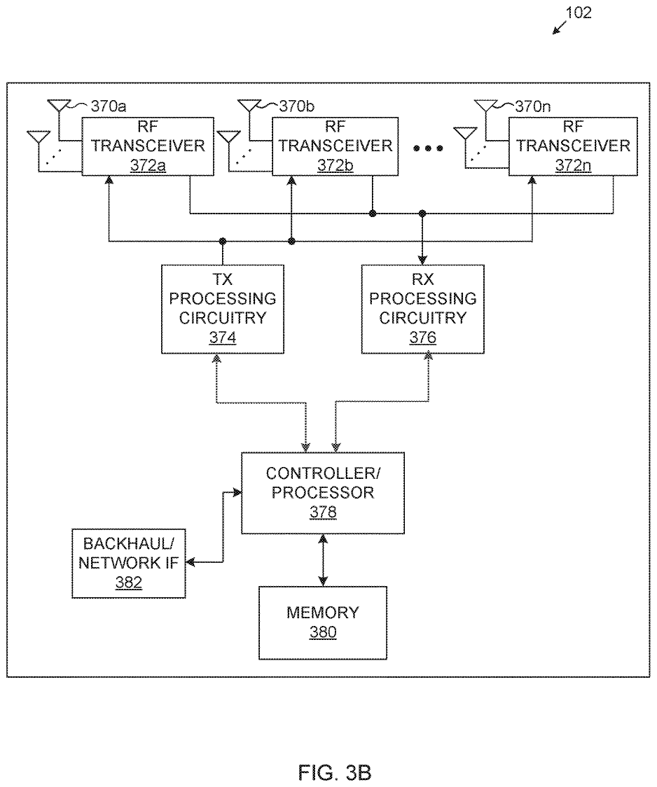

FIG. 3A illustrates an example UE 116 according to the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of the present disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a processor 340, an input/output (I/O) interface 345, an input 350, a display 355, and a memory 360. The memory 360 includes an operating system (OS) program 361 and one or more applications 362.

The RF transceiver 310 receives, from the antenna 305, an incoming RF signal transmitted by a gNB of the wireless network 100 of FIG. 1. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS program 361 stored in the memory 360 in order to control the overall operation of the UE 116. For example, processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS program 361 or in response to signals received from gNBs or an operator. The processor 340 is also coupled to the I/O interface 345, which provides the UE 116 with the ability to connect to other devices such as laptop computers and handheld computers. The I/O interface 345 is the communication path between these accessories and the processor 340.

The processor 340 is also coupled to the input 350 (e.g., keypad, touchscreen, button etc.) and the display 355. The operator of the UE 116 can use the input 350 to enter data into the UE 116. The display 355 can be a liquid crystal display or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3A illustrates one example of UE 116, various changes can be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3A illustrates the UE 116 configured as a mobile telephone or smartphone, UEs could be configured to operate as other types of mobile or stationary devices.

FIG. 3B illustrates an example gNB (base station) 102 according to the present disclosure. The embodiment of the gNB 102 shown in FIG. 3B is for illustration only, and other gNBs of FIG. 1 could have the same or similar configuration. However, gNBs come in a wide variety of configurations, and FIG. 3B does not limit the scope of the present disclosure to any particular implementation of a gNB. The gNB 101 and the gNB 103 can include the same or similar structure as the gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include two-dimensional (2D) antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of forward channel signals and the transmission of reverse channel signals by the RF transceivers 372a-372n, the RX processing circuitry 376, and the TX processing circuitry 374 in accordance with well-known principles. The controller/processor 378 could support additional functions as well, such as more advanced wireless communication functions. In some embodiments, the controller/processor 378 includes at least one microprocessor or microcontroller.

The controller/processor 378 is also capable of executing programs and other processes resident in the memory 380, such as an OS. The controller/processor 378 is also capable of utilizing beam and SB mapping in JPTAs described in embodiments of the present disclosure. In some embodiments, the controller/processor 378 supports communications between entities. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 could support communications over any suitable wired or wireless connection(s). For example, when the gNB 102 is implemented as part of a cellular communication system (such as one supporting 5G or new radio access technology or NR, LTE, or LTE-A), the backhaul or network interface 382 could allow the gNB 102 to communicate with other gNBs over a wired or wireless backhaul connection. When the gNB 102 is implemented as an access point, the backhaul or network interface 382 could allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 could include a RAM, and another part of the memory 380 could include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

Although FIG. 3B illustrates one example of a gNB 102, various changes can be made to FIG. 3B. For example, the gNB 102 could include any number of each component shown in FIG. 3A. As a particular example, an access point could include a number of backhaul or network interfaces 382, and the controller/processor 378 could support routing functions to route data between different network addresses. As another particular example, while shown as including a single instance of TX processing circuitry 374 and a single instance of RX processing circuitry 376, the gNB 102 could include multiple instances of each (such as one per RF transceiver).

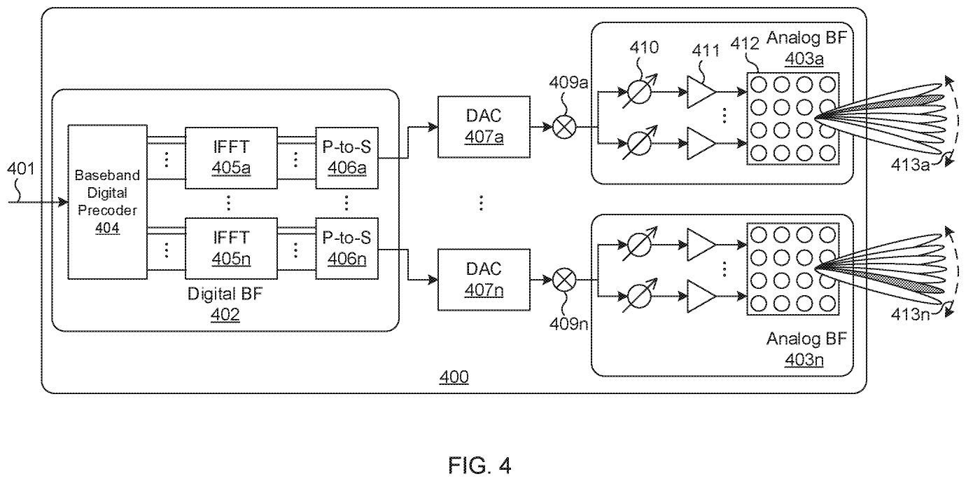

FIG. 4 illustrates an example beamforming architecture that may be used in connection with either hybrid beamforming for open radio access network (O-RAN) fronthaul or transmission of control information over O-RAN fronthaul for JPTAs according to embodiments of the present disclosure. The embodiment of the beamforming architecture 400 shown in FIG. 4 is for illustration only. FIG. 4 does not limit the scope of this disclosure to any particular implementation of a beamforming architecture. It is noted that the beamforming architecture 400 or a similar structure may be implemented within any of gNB 101, gNB 102, and/or gNB 103 in FIG. 1. It is noted that the beamforming architecture 400 or a similar structure may be implemented within any of RF transceiver 372a, RF transceiver 372b, and/or RF transceiver 372n in FIG. 3B.

The beamforming architecture 400 receives input signal(s) 401 corresponding to signals to the transmitted. The beamforming architecture 400 includes digital beamforming circuitry 402 and a plurality of instances of analog beamforming circuitry 403a-403n. The digital beamforming circuitry 402 includes a baseband digital precoder 404 that receives the input signal(s) 401 and outputs signals for a number of circuitry chains corresponding to the number of channel state information reference signal (CSI-RS) ports. Each of those circuitry chains includes an instance of an IFFT block 405a-405n and an instance of a parallel-to-serial block 406a-406 n. The outputs of those circuit chains within the digital beamforming circuitry 402 are passed to a corresponding DAC 407a-407n, the outputs of which are passed via a mixer 409a-409n to one of the instances of analog beamforming circuitry 403a-403n. Each instance of the analog beamforming circuitry 403a-403n includes a plurality of circuit chains including an analog phase shifter 410 and a power amplifier (PA) 411 connected in series to each other and to an array 412 of antenna elements. Each instance of the analog beamforming circuitry 403a-403n transmits on at least one beam within a plurality of beams 413a-413n.

For mmWave bands, although the number of antenna elements can be larger for a given form factor, the number of CSI-RS ports—which can correspond to the number of digitally precoded ports—tends to be limited due to hardware constraints (such as the feasibility to install a large number of analog-to-digital converters (ADCs)/digital-to-analog converters (DACs) at mmWave frequencies) as illustrated by beamforming architecture 400 in FIG. 4. In this case, one CSI-RS port is mapped onto a large number of antenna elements, which can be controlled by a bank of analog phase shifters 410. One CSI-RS port can then correspond to one sub-array producing a narrow analog beam through analog beamforming 403a-403n. This analog beam can be configured to sweep across a wider range of angles (encompassed by beams 413a, beams 413n, etc.) by varying the phase shifter bank across symbols or subframes or slots (where a subframe or a slot comprises a collection of symbols and/or can comprise a transmission time interval (TTI)). The number of sub-arrays (equal to the number of RF chains) is the same as the number of CSI-RS ports NCSI-PORT. The digital beamforming circuitry 402 performs a linear combination across NCSI-PORT analog beams to further increase precoding gain. While analog beams are wideband (hence not frequency-selective), digital precoding can be varied across frequency SBs or resource blocks (RBs).

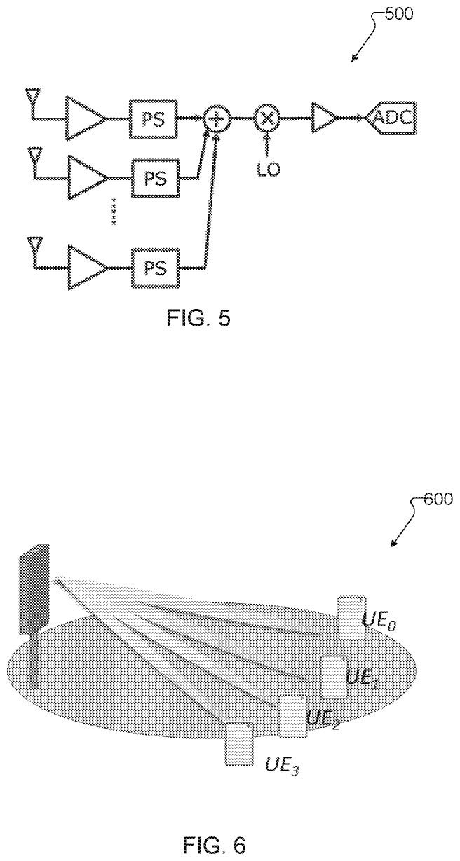

FIG. 5 illustrates a diagram of an example phase-shifter based frequency-flat hybrid beamforming 500 according to embodiments of the present disclosure.

With reference to FIG. 5, some approaches can use a phase-shifter array or a combination of phase-shifters and switches to connect the large antenna array to a few of RF chains.

For example, with reference to FIG. 4, the case of hybrid beamforming at a BS with a single RF chain, i.e., R=1, is evaluated. However, with reference to FIG. 5, some approaches can use a phase-shifter array or a combination of phase-shifters and switches to connect the large antenna array to a few of RF chains.

FIG. 6 illustrates an example of a JPTA beamforming 600 on a beam set according to various embodiments of the present disclosure. For example, the JPTA beamforming 600 may be performed by the BS 102 in the network 101. The JPTA beamforming 600 is for illustration only and other embodiments can be used without departing from the scope of the present disclosure.

In FIG. 6, data is received by UE₀-UE₄ using analog beams. Note that this is just an illustrative example, the network 101 may have 10s or 100s of beams. For the JPTA operation, UEs located at the cell edge have a greater chance of UL transmission in the time domain. The UE can thus transmit multiple replicas of the physical uplink control channel (PUCCH) and/or physical uplink shared channel (PUSCH) packets, which boosts the effective signal to interference and noise ratio (SINR) and thus facilitates the decoding at the BS. The total time-frequency radio resource assigned to cell edge UE can be the same between analog and JPTA beamforming. However, the UE in the JPTA operation can deliver more energy to the BS because of a longer uplink transmission duration. The result of JPTA beamforming being applied to the UEs enable the UL signals to be received simultaneously in a single UL slot.

Embodiments of the present disclosure recognize that not all UL channels/signals may require coverage enhancement via JPTA operation. Therefore, in various embodiments, the gNB applies JPTA to a subset of UL channels/signals transmitted by the UEs experiencing cell edge condition.

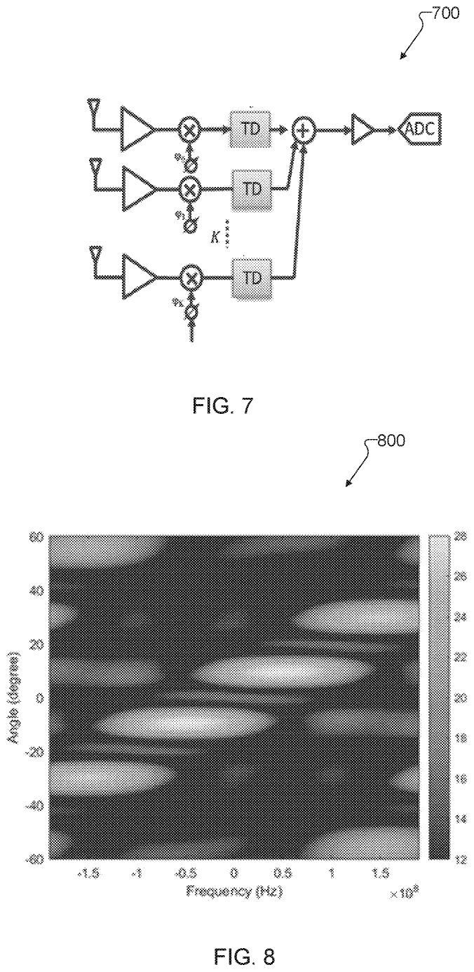

FIG. 7 illustrates a diagram of an example JPTA circuit 700 according to embodiments of the present disclosure. For example, the JPTA circuit 700 may be implemented in the BS 102. This example is for illustration only and other embodiments can be used without departing from the scope of the presence disclosure.

As noted above, JPTA beamforming is an alternative to frequency-flat hybrid beamforming. Note that, here, frequency-dependent beamforming can refer to a technique where different components of the input signal may encounter a differently shaped analog beam based on their frequency. To this end, with reference to FIG. 7, time delay units are utilized in addition to the common phase shifters to create the desired frequency-dependent beam.

By tuning the time delay units and phase shifters, different frequency-dependent beams can be designed. FIG. 8 illustrates an example of a JPTA beam pattern 800 is for a 2D beam pattern for JPTA discrete-angle beam according to embodiments of the present disclosure. The example JPTA beam pattern 800 is for a 2D beam pattern for JPTA discrete-angle beam, where the angles in [−30, −15, 15, 30] are associated with distinct bundles of subcarriers that provide high beam gain. In this case, the BS designs the JPTA to maximize the beam gain for UEs at different angles over distinct continuous sets of subcarriers.

In contrast to phased-array beamforming, UEs at different angles can be served at the same over distinct bundles of sub-carriers without the need for beam sweeping. For example, UEs at [−30, −15, 15, 30] can be simultaneously served over the corresponding subcarrier (i.e., frequency SBs). As a result, every UE has access to the channel, which can be exploited for different purposes including fast beam-training, uplink coverage extension, and mobility enhancement.

In one or more embodiments, to design a JPTA beam like the one shown in FIG. 8, the BS 102 may need to set the phase values in the phase shifters and the time delay values in the time delay units based on the information available at the BS 102. Specifically, the BS 102 can be assumed to know the directions, or angle of arrival (AoA)/angle of departure (AoD), to which it will point its JPTA beam and the sub-carriers (or frequency band) assigned to the each AoA. The BS 102 can select the delay and phase values to maximize the beam gain at each AoA over the sub-carriers assigned to the direction. Various algorithms can design the JPTA beam and solve the beamforming problem with different complexities and different performance. There can be different hardware implementations, which differ in terms of hardware complexity.

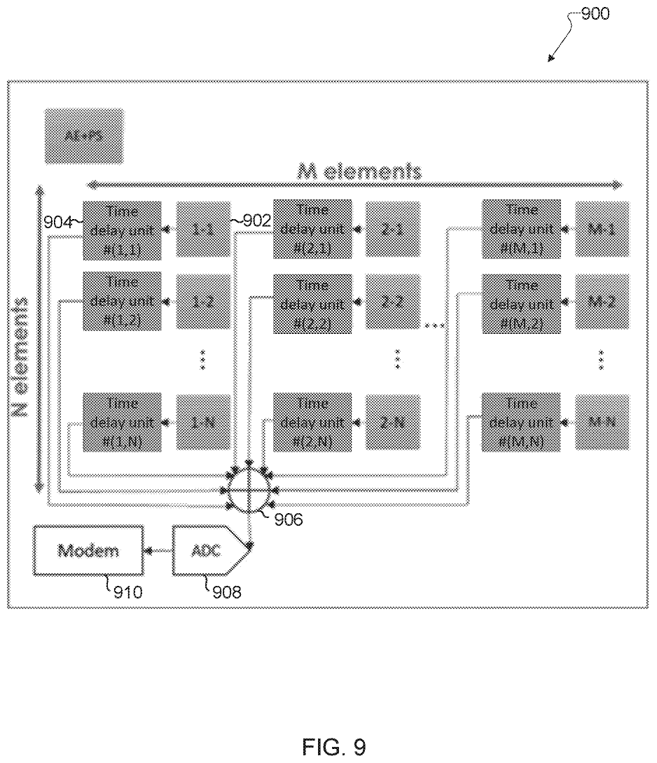

FIG. 9 illustrates an example array of antenna elements (AEs) 900 used in three-dimensional (3D) JPTA according to embodiments of the present disclosure. In one or more embodiments, each AE 902 the array of AEs 900 is connected through a dedicated phase shifter and time delay unit 904. As shown in FIG. 9, each AE 902 is illustrated as including the dedicated phase shifter. Each of the time delay units 904 are electrically coupled to a mixer 906. The mixer 906 is electrically connected to an analog-to-digital converter (ADC) 908 which is electrically connected to a modem 910. However, due to the relatively large number of time delay units, wiring each individual time delay unit 904 can be a challenge. Thus, in one or more embodiments, there can be other JPTA architectures to reduce the number of time delay units 904 by connecting each time delay unit to a group of AEs.

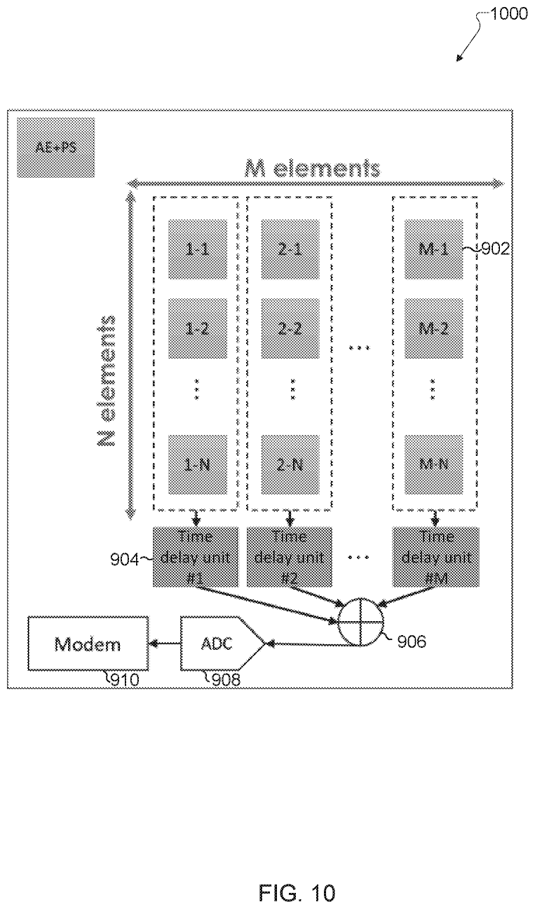

FIG. 10 illustrates an example array of AEs 1000 used in azimuth-only JPTA according to embodiments of the present disclosure. In azimuth-only JPTA each column of the array AEs 1000 is coupled to a single time delay unit 904. However, this simplification can impose scheduling restrictions since the JPTA beam can point to a single elevation angle at any given time. The elevation angle can be changed, since each AE 902 is still controlled by a phase shifter.

In one or more embodiments, in elevation-only JPTA, each row of the AEs 902 can be connected through a single time delay unit 904. However, this can impose scheduling restrictions since the JPTA beam can point to a single azimuth angle at any given time. The elevation angle can be changed, since each AE 902 is still controlled by a phase shifter. As noted above, azimuth-only and elevation-only JPTA are known as 2D JPTA, because the beamforming is done across frequency and a single spatial dimension.

For 2D JPTA, the scheduler is restricted to schedule users on the same elevation beam for azimuth-only JPTA and the same azimuth beam for elevation-only JPTA. These scheduling restrictions are imposed by the architecture, and the scheduler (software) has to accommodate that to avoid scheduling users on directions on which the hardware is incapable of serving simultaneously.

However, there can be high resolution beam codebooks for providing higher coverage and throughput for fixed wireless access at mmWave bands. With a larger number of beams, a higher beam gain is expected, which directly translates to higher signal-to-noise ratio (SNR). If combined with JPTA, this merge may need to be accounted for due to the larger number of beam combinations to be supported by JPTA. Furthermore, depending on the angles, SB assignment, and beamforming algorithm, the JPTA beam gain in the desired direction over the corresponding SBs is different. For some beam combination and SB assignment the users can experience low beam gain. Memory constraints can limit the number of JPTA beams that can be stored in the modem and radio frequency front end (RFFE). Merging JPTA with high resolution codebooks have major effects on the JPTA operation. To support the larger number of beam combinations, the JPTA codebook size increases. Hence, codebook optimization can be useful to satisfy the memory constraints. Additionally, challenges are expected for 2D JPTA, where the scheduler is restricted to scheduler users on the same elevation beam for azimuth-only JPTA and the same azimuth beam for elevation-only JPTA. Increasing the number of beams leads to smaller number of users that share the same elevation (or azimuth) beam in azimuth-only (or elevation-only) JPTA decreases which reduces the JPTA scheduling opportunity. The lower scheduling opportunity, a pre-log factor for the throughput, can potentially undo the benefit of the higher beam gain, post log factor for the throughput, expected from high resolution codebooks.

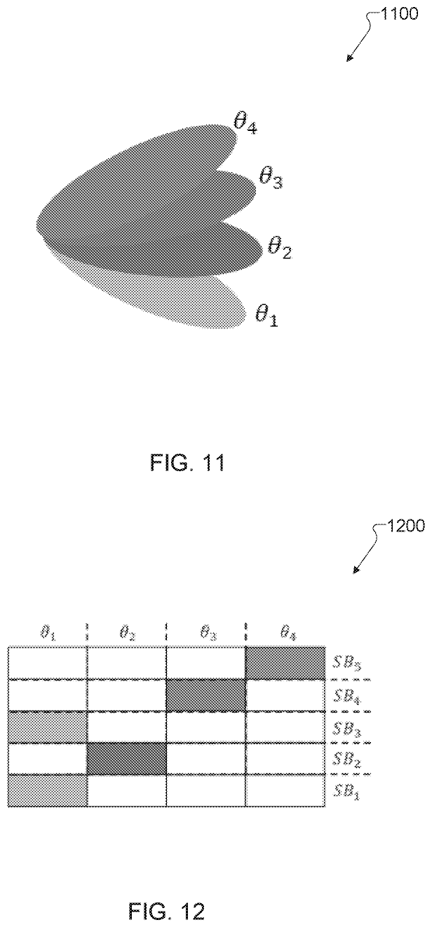

FIG. 11 illustrates an example JPTA beam 1100 according to embodiments of the present disclosure.

In one or more embodiments, the BS 102 assigns contiguous SBs to each beam. As shown in FIG. 11, the BS 102 can point the JPTA beam 1100 in four different directions denoted by θ₁-θ₄, respectively. In one or more embodiments, two SBs can be assigned to θ₁ and a single SB for the other directions. It is understood that the BS 102 can point the JPTA beam 1100 in any suitable quantity of directions and any suitable quantity of SBs can be assigned to any direction.

FIG. 12 illustrates an example SB assignment 1200 for the example JPTA beam 1100 of FIG. 11 without any scheduling restrictions according to embodiments of the present disclosure.

Without any scheduling restrictions, the SB assignment 1200 shown in FIG. 12 can be used. However, the SB assignment 1200 could result in high beam gain loss since the SBs assigned to θ₁ are not contiguous.

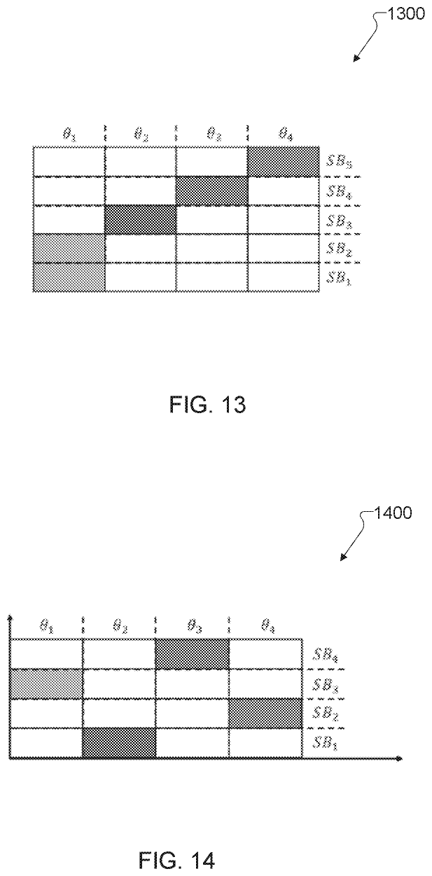

FIG. 13 illustrates an example SB assignment 1300 for the example JPTA beam 1100 of FIG. 11 with contiguous SB allocation according to embodiments of the present disclosure. The SB assignment 1300 shown in FIG. 13 includes contiguous SB allocation. Advantageously, contiguous SB allocation simplifies the JPTA beam 1100 and results in smaller beam gain loss regardless of the JPTA hardware architecture, i.e., azimuth-only, elevation-only, 3D JPTA.

The contiguous SB allocation of the SB assignment 1300 may require the delay and phase values in the time delay units and phase shifters, respectively, to be set accordingly. In a codebook-based approach, such restriction can be inherently reflected in the codebook design. For an online beamforming scheme, where the beams are designed based on input from the medium access control (MAC) layer, the MAC scheduler may need to be aware of the scheduling restrictions. Note that the scheduler may need to be changed or augmented by new blocks as outlined in to support JPTA. The contiguous allocation can be ideally implemented as part of the logic used in the scheduler. Alternatively, the scheduling could be done without restrictions and then the SB allocation can be rearranged to ensure contiguous SB allocation. This can lead to sub-optimal mapping but can be simpler to implement.

FIG. 14 illustrates an example SB assignment 1400 for the example JPTA beam 1100 of FIG. 11 without any scheduling restrictions for azimuth-only JPTA according to embodiments of the present disclosure.

In one or more embodiments, SB allocation across the beams can be based on their relative angles. Consider a BS 102 with azimuth-only JPTA pointing the JPTA beam 1100 in four different directions as shown in FIG. 11. Assume that a single SB is assigned to each direction. Without scheduling restrictions, the SB assignment 1400 of FIG. 14 would be used.

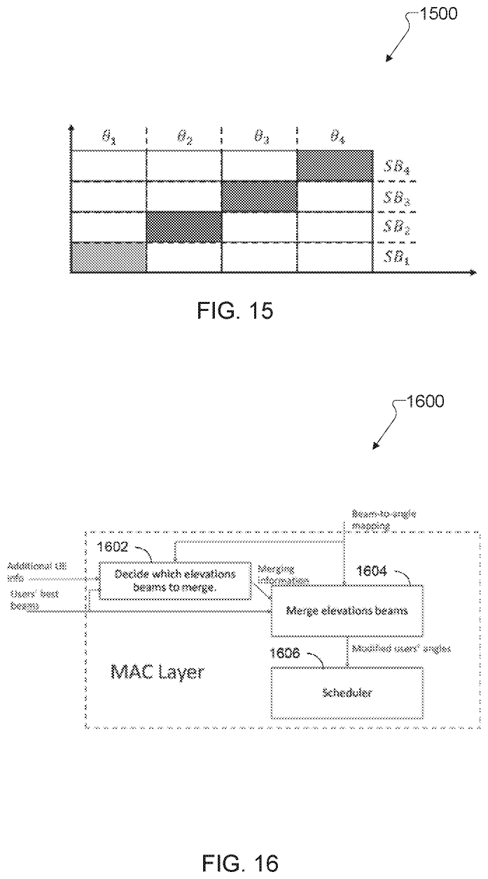

FIG. 15 illustrates an example SB assignment 1500 for the example JPTA beam 1100 of FIG. 11 using monotone SB and beam mapping according to embodiments of the present disclosure. As shown in the SB assignment 1500 of FIG. 15, when using monotone SB and beam mapping, the SB can be assigned to the right-most beam, the 2^{nd} SB can be assigned to the 2^{nd} right most beam, and so on. Advantageously, assigning SBs using monotone SB and beam mapping (the SB assignment 1500) preserves the number of resources assigned to each beam in the SB assignment 1400 FIG. 14, while maintaining a monotone allocation.

In one or more embodiments, achieving monotone SB and beam mapping depends on the hardware architecture itself, i.e., azimuth-only, elevation-only, or 3D JPTA. In azimuth-only JPTA the beams can be ordered based on their horizontal (beam) pointing angles. The first SB, i.e., lowest frequency, can be assigned to the rightmost beam, the second to the second right most, and continue monotonically until the last SB (highest frequency) is assigned to the leftmost beam. In other embodiments, the SB assignment can be ordered from the leftmost beam to the rightmost beam. In elevation-only JPTA the beams can be ordered based on their elevation (beam) pointing angles. The first SB, i.e., lowest frequency, can be assigned to the first beam and continue monotonically until the last SB (highest frequency) is assigned to the last beam. The beam ordering can be done by starting with the beam pointing to the highest elevation angle or the lowest. In 3D JPTA, the JPTA beam could point to different elevation and azimuth angles simultaneously. Different options can be used to have monotone SB and beam mapping. In all of these options, the BS can allocate the SB with the lowest frequency to the first beam, then monotonically continue the assignment until the SB with the highest frequency is assigned to the last beam, or vice versa, i.e., start with the highest frequency first. The beam ordering could be done in any of the following options: azimuth ordering, elevation ordering, and angular distance. In azimuth ordering the beams can be ordered based on their azimuth pointing angles irrespective of the elevation pointing angle. In elevation ordering the beams can be ordered based on their elevation pointing angles irrespective of the azimuth pointing angle. In angular distance ordering a reference point (azimuth and elevation angles pair) can be picked, then the beams can be ordered based on their angular distance to the reference point. The reference point could be simply the origin (0°, 0°), or any of the corners of the coverage region. Alternately in the beams can be ordered based on their 2D angular distance, their horizontal distance, and/or their vertical distance from a reference beam.

Similar to contiguous JPTA SB allocation, the monotone SB allocation may require the delay and phase values in the time delay units and phase shifters, respectively, to be set accordingly. In a codebook-based approach, such restriction can be inherently reflected in the codebook design. For an online beamforming scheme, where the beams are designed based on input from the MAC layer, the MAC scheduler may need to be aware of these scheduling restrictions.

In some embodiments, the scheduler may need to be changed or augmented by new blocks as outlined in to support JPTA. The contiguous allocation can be ideally implemented as part of the logic used in the scheduler. Alternatively, the scheduling could be done without restrictions and then the SB allocation can be rearranged to ensure contiguous SB allocation. This option can lead to sub-optimal mapping but can be simpler to implement.

As noted above, merging JPTA and high-resolution beam codebooks can be especially challenging for 2D JPTA. The challenge is due to the restriction in 2D JPTA to schedule users (also referred to herein as “UEs”) on the same elevation beam for azimuth-only JPTA and the same azimuth beam for elevation-only JPTA. Increasing the number of beams leads to a smaller number of users that share the same elevation (azimuth) beam in azimuth-only (elevation-only) JPTA decreases which reduces the JPTA scheduling opportunity.

In a typical JPTA operation, a codebook-based beamforming is used for downlink data and CSI-RS measurements and JPTA is only turned on for uplink. Based on this, the JPTA scheduler has the CSI-RS measurement reported by the users as its input. More specifically, the scheduler does not know the exact AoAs/AoDs for the users, but could use the best beam reported by each user to approximate its angular locations. By grouping the users with the same beam as best beam and assigning the pointing angle of the beam to the users as their angular location, the AoAs/AoDs of the users can be approximated. With these angular locations, the scheduler picks which users to schedule and the scheduling restrictions for 2D JPTA are applied. For example, in azimuth-only JPTA, the scheduler can only select users on the same elevation angle, which is the same as the pointing elevation angle of their best beam. In other words, all scheduled users may need to share the same elevation beam. With the higher angular fidelity of the high-resolution beams, this leads to lower number of users that can be scheduled together, reducing the JPTA scheduling opportunity.

To resolve the problem of JPTA scheduling opportunity with high-resolution beams, the BS 102 could preprocess the pointing angles of the users before or at the scheduler. In one or more embodiments, the BS 102 could combine users on adjacent rows of beams together (merge UEs on different elevation beams into at least one group) and set the same elevation angle for these users (assign each of the at least one groups an elevation angle). The new elevation angle could be the average (simple average) of the pointing angles of elevation beams, or could be the weighted average (of each of the beams in the at least one group) based on the number of users on each elevation beams.

To resolve the codebook size, the merging may happen while designing the codebook based on site-specific or typical users'distribution. For an online design, the BS 102 has more freedom, and different options can be utilized to dynamically merge beams. In one or more embodiments, the BS 102 could turn on/off merging every two adjacent rows of beams based on the number of users and/or the distribution of user's angles. In other embodiments, the BS 102 can selectively pick which adjacent rows of beams to merge based on the number of users on each row or other metrics such as sum proportional fairness. In another embodiment, the BS 102 can predict the beam gain loss caused by merging two rows of beams and the potential scheduling gain to determine whether to merge or not.

FIG. 16 illustrates a flowchart for an example method 1600 for margining user beams according to one or more embodiments of the present disclosure. In one or more embodiments, the method 1600 can be performed in the MAC layer of the BS 102. The method 1600 begins with the BS 102 deciding which elevation beams to merge (1602). The BS 102 decides which elevation beams to merge based on merging information including the users'distribution (such as whether a quantity of beams that share a elevation as a primary beam is greater than a threshold quantity of users), their RSRP, buffer status report, expected beamforming loss from merging, the users'(UEs) best beams, and other available metrics (additional UE or user information). In one or more embodiments, the merging information could be simply which beams to merge and new pointing angles of the merged beams. Next, users are merged based on their best elevation beams and the merging information (1604). From there, the elevation and azimuth angles of the users are then derived from the best beam information based on a look up table for unmerged beams and the merging information from the first block for merged beams, and the modified user's angles are passed to the scheduler (1606).

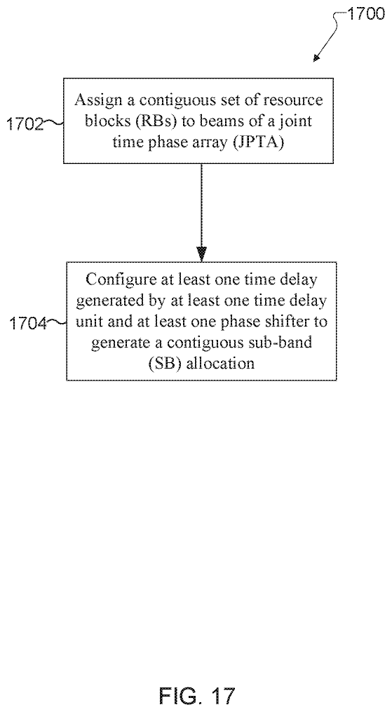

FIG. 17 illustrates a flowchart for an example method for beam and SB mapping in JPTAs according to an embodiment of the present disclosure. The method 1700 begins with the BS 102 assigning a contiguous set of resource blocks (RBs) to beams of a JPTA (1702). Next, after assigning the contiguous set of RBs, the BS 102 can configure at least one time delay generated by at least one time delay unit 904 and at least one phase shifter (included in each AE 902) to generate a contiguous SB allocation. For example, as illustrated in FIG. 13, the BS 102 can configure at least one time delay unit 904 and phase shifter to assign SBs in a contiguous manner as shown in the SB assignment 1300. Additionally or alternatively, the BS 102 can configure at least one time delay generated by at least one time delay unit 904 and at least one phase shifter to assigned at least one RB or SB monotonically, as shown in the SB assignment 1500 and described in FIG. 15, and/or different users on different elevation beams can be included into at least one group, with each group being assigned an elevation angles as described in FIG. 16.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating a base station (BS), the method comprising:
assigning a contiguous set of resource blocks (RBs) to beams of a joint phase-time array (JPTA); and
configuring at least one time delay generated by at least one time delay unit and at least one phase shifter to generate a contiguous sub-band (SB) allocation.

2. The method of claim 1, further comprising assigning at least one RB or SB allocation to the beams monotonically.

3. The method of claim 2, wherein the at least one RB or SB allocation is monotonically assigned based on a beam pointing angle in an azimuth-only JPTA.

4. The method of claim 2, wherein the at least one RB or SB allocation is monotonically assigned based on a beam pointing angle in an elevation-only JPTA.

5. The method of claim 2, wherein the at least one RB or SB allocation is monotonically assigned based on a horizonal distance, a vertical distance, or a two-dimensional (2D) angular distance relative to a reference beam in a three-dimensional (3D) JPTA.

6. The method of claim 1, further comprising including user equipment (UEs) on different elevation beams into at least one group.

7. The method of claim 6, further comprising assigning an elevation angle to each of the at least one group.

8. The method of claim 7, wherein the UEs are merged based on whether a quantity of UEs that share a same elevation as a primary beam is less than a threshold quantity of UEs.

9. The method of claim 7, wherein the assigned elevation angle is the elevation of a primary beam.

10. The method of claim 7, wherein the assigned elevation angle is a weighted average of elevation angles of each of the beams in the at least one group or a simple average of the elevation angles of each of the beams in the at least one group.

11. A base station (BS), comprising:
an antenna element (AE) array comprising:
at least one row of AEs and at least one column of AEs;
at least one time delay unit, wherein a time delay unit is coupled to each row of AEs, a time delay unit is coupled to each column of AEs, or a time delay unit is coupled to each of the AEs; and
at least one phase shifter connected to each of the AEs, wherein the BS is configured to:
assign a contiguous set of resource blocks (RBs) to beams of a joint phase-time array (JPTA); and
configure at least one time delay generated by the at least one time delay unit and at least one phase shifter to generate a contiguous sub-band (SB) allocation.

12. The BS of claim 11, wherein the BS is further configured to assign at least one RB or SB allocation to the beams monotonically.

13. The BS of claim 12, wherein the at least one RB or SB allocation is monotonically assigned based on a beam pointing angle in an azimuth-only JPTA.

14. The BS of claim 12, wherein the at least one RB or SB allocation is monotonically assigned based on a beam pointing angle in an elevation-only JPTA.

15. The BS of claim 12, wherein the at least one RB or SB allocation is monotonically assigned based on a horizonal distance, a vertical distance, or a two-dimensional (2D) angular distance relative to a reference beam in a three-dimensional (3D) JPTA.

16. The BS of claim 11, wherein the BS is further configured to merge user equipments (UEs) on different elevation beams into at least one group.

17. The BS of claim 16, wherein the BS is further configured to assign an elevation angle to each of the at least one group.

18. The BS of claim 17, wherein the UEs are merged based on whether a quantity of UEs that share a same elevation as a primary beam is less than a threshold quantity of UEs.

19. The BS of claim 17, wherein the assigned elevation angle is the elevation of a primary beam.

20. The BS of claim 17, wherein the assigned elevation angle is a weighted average of elevation angles of each of the beams in the at least one group or a simple average of the elevation angles of each of the beams in the at least one group.
